(19) United States
(12) Patent Application Publication
(10) Pub. No.: US 2006/0104276 A1
(43) Pub. Date: May 18, 2006

(54) Dynamic hover text for HTML table cells

(75) Inventors: Indran Naick, Cedar Park, TX (US); Jeffrey Kenneth Wilson, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/992,515

(22) Filed: Nov. 18, 2004

(51) Int. Cl. H04L 12/56; H04L 12/28

(52) U.S. Cl. 370/392

(57) ABSTRACT

A method, apparatus, and computer instructions for displaying header information in a table. Responsive to a movement of a pointer over a table displayed in a window, a cell in the table over which the pointer is located is identified. A determination of whether a header associated with the cell is out of view in the window in response to identifying the cell. Responsive to the header being out of view, contents of the header are displayed.

### BACKGROUND OF THE INVENTION

1. Technical Field

The present invention relates generally to an improved data processing system, and in particular to a method and apparatus for processing data. Still more particular, the present invention relates to a method, apparatus, and computer instructions for displaying tables in windows.

2. Description of Related Art

The use of tables in documents is a common practice for presenting data to a user in conjunction with an explanation of the data. Tables are found in many documents, such as opinions, prospectuses, brochures, and magazines. These documents often are distributed in electronic form on Websites over the Internet. Tables are frequently generated using a spreadsheet program, such as Microsoft Excel from Microsoft Corporation. Tables also may be generated using a word processing program.

With respect to distributing documents electronically, tables are frequently generated in a manner that the display of the information in the table spans beyond the visible portion of a browser. As a result, portions of the table may be out of the user's view. This inability to view the entire table can cause a usability issue if information in a header describing a particular cell, row, or column is out of view. As a result, a user is required to scroll up and down or left and right to see the header information for a particular cell, row, or column. A header contains information describing the contents of a row or column.

For example, a header may indicate that a particular row or column contains address information. Such a header may read as follows “employee address”. If a user cannot see this header, the user may be unable to identify the contents of a cell as the address for an employee. As a result, the user has to scroll the window to see the header for this particular cell if the header is out of view in the browser.

Some methods have been employed to deal with this issue. These methods include programming the table with dynamic hypertext markup language (HTML) and Java script using special HTML tags. Another method uses plug-ins to dump the contents of the table into a spreadsheet program to use internal functions of the spreadsheet program to allow for easier viewing of header information in the table.

These currently used methods have usability issues. For example, programming the table to include additional functionality requires additional programming efforts. Further, this additional functionality requires skills that many HTML programmers do not have or care to use. As a result, most tables on Web pages do not include this type of functionality. Sending the contents of a table to a spreadsheet program has its own set of problems. This solution requires the end user to have a copy of the spreadsheet program. Further, placing information into a spreadsheet program such as Microsoft Excel requires awkward steps in addition to owning a license for the program.

Thus, these currently available solutions are not optimal with respect to presenting content to users. Therefore, it would be advantageous to have an improved method, apparatus, and computer instructions for displaying tables in a data processing system.

### SUMMARY OF THE INVENTION

The present invention provides a method, apparatus, and computer instructions for displaying header information in a table. Responsive to a movement of a pointer over a table displayed in a window, a cell in the table over which the pointer is located is identified. A determination of whether a header associated with the cell is out of view in the window in response to identifying the cell. Responsive to the header being out of view, contents of the header are displayed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in accordance with a preferred embodiment of the present invention;

FIG. 3 is a block diagram of a browser program in accordance with a preferred embodiment of the present invention;

FIG. 4 is a diagram of table in accordance with a preferred embodiment of the present invention;

FIGS. 5A-5C are diagrams illustrating the display of a table in accordance with a preferred embodiment of the present invention;

FIG. 6 is a diagram illustrating a menu with preferences for displaying text in accordance with a preferred embodiment of the present invention;

FIG. 7 is a flowchart for a process for displaying a table in a window in accordance with a preferred embodiment of the present invention; and

FIG. 8 is a flowchart of a process for displaying in which a user selects headers in accordance with a preferred embodiment of the present invention.

### DETAILED DESCRIPTION OF THE PREFERRED EMBODIMENT

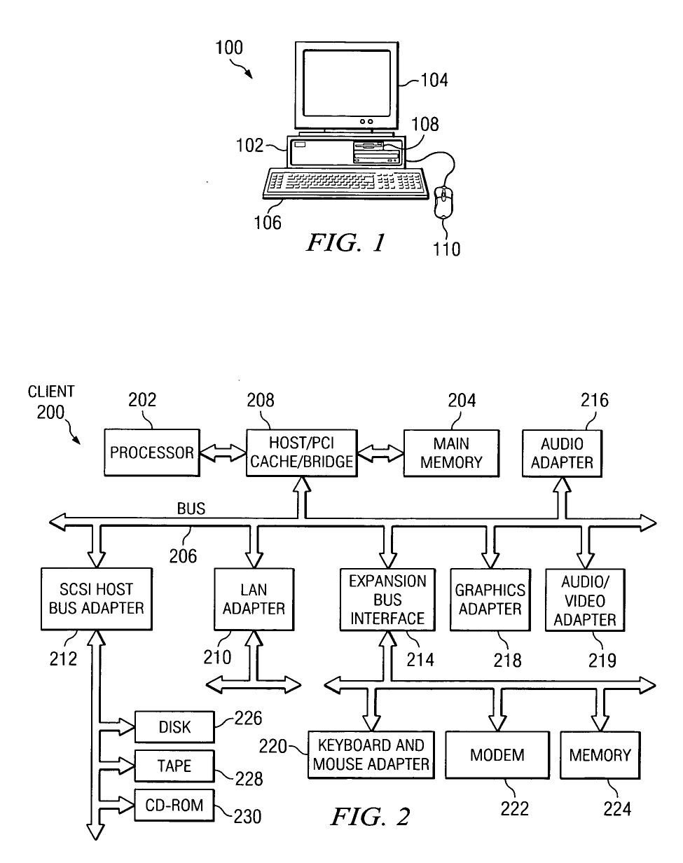

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI), host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230. In particular, the present invention provides a method, apparatus, and computer instructions for displaying header information from header cells to a user without requiring the user to scroll a window in which the table is displayed. The mechanism of the present invention presents the information in the header cell or cells to the user in a window. In these illustrative examples, the mechanism of the present invention is implemented in a browser.

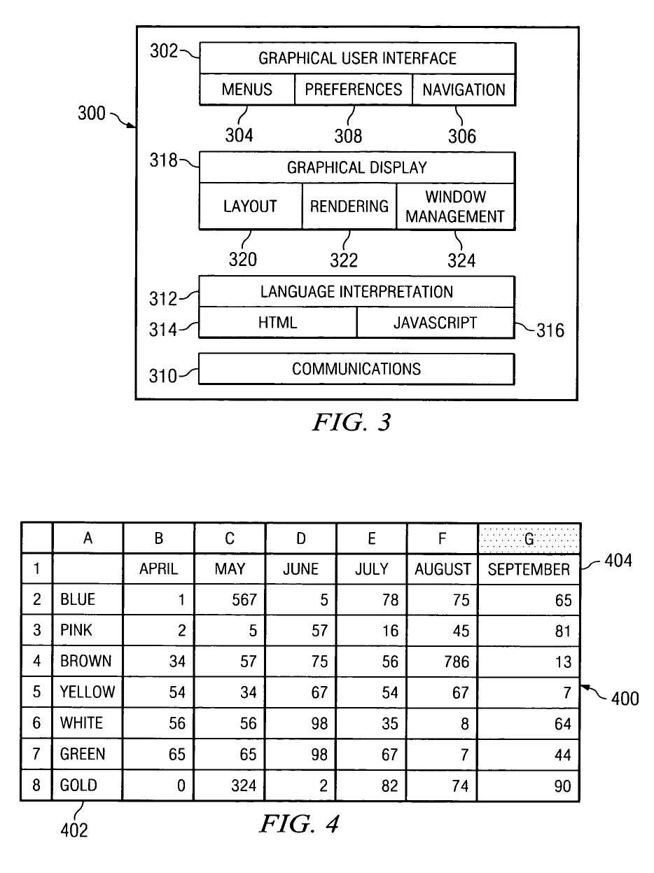

Turning next to FIG. 3, a block diagram of a browser program is depicted in accordance with a preferred embodiment of the present invention. A browser is an application used to navigate or view information or data in a distributed database, such as the Internet or the World Wide Web.

In this example, browser 300 includes a user interface 302, which is a graphical user interface (GUI) that allows the user to interface or communicate with browser 300. This interface provides for selection of various functions through menus 304 and allows for navigation through navigation 306. For example, menu 304 may allow a user to perform various functions, such as saving a file, opening a new window, displaying a history, and entering a URL. Navigation 306 allows for a user to navigate various pages and to select Websites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communication 310 uses HTTP. Other protocols may be used depending on the implementation. Documents that are received by browser 300 are processed by language interpretation 312, which includes an HTML unit 314 and a JavaScript unit 316. Language interpretation 312 will process a document for presentation on graphical display 318. In particular, HTML statements are processed by HTML unit 314 for presentation while JavaScript statements are processed by JavaScript unit 316.

Graphical display 318 includes layout unit 320, rendering unit 322, and window management 324. These units are involved in presenting Web pages to a user based on results from language interpretation 312.

Browser 300 is presented as an example of a browser program in which the present invention may be embodied. Browser 300 is not meant to imply architectural limitations to the present invention. Presently available browsers may include additional functions not shown or may omit functions shown in browser 300. A browser may be any application that is used to search for and display content on a distributed data processing system. Browser 300 may be implemented using known browser applications, such as Netscape Navigator or Microsoft Internet Explorer. Netscape Navigator is available from Netscape Communications Corporation while Microsoft Internet Explorer is available from Microsoft Corporation.

In the depicted examples, the mechanism of the present invention may be implemented in different components within browser 300. For example, the mechanism of the present invention may be implemented in graphical user interface 302. Another component in which the mechanism may be implemented is, for example, window management 324.

The present invention in these illustrative examples employs a mechanism similar to that for providing hover text for a pop up text block. This type of display also is referred to as a “tool tip”. Text is presented to the user from one or more headers in the table without requiring the user to scroll for the user to see this information. This mechanism also does not require a programmer to include functionality through Java script or dynamic HTML instructions. In these examples, the headers are illustrated as being at the top of the column at the left of the row. These headers describe the contents of a particular row or column. By placing a pointer over a cell, the browser initiates popup text for the contents of the table/header cell or a standard or upper left cell.

In addition, the mechanism of the present invention may enable a browser to identify the header that is not displayed in the window. One way of identifying this situation is by noting the top position of the top left corner of the table and comparing that position to the position of the scroll bar. Further, the browser may listen for or look for headers that are displayed and act on this situation without requiring special programming by programmers creating Web pages.

Turning next to FIG. 4, a diagram of table is depicted in accordance with a preferred embodiment of the present invention. In this example, table 400 contains header information in column 402 and in row 404. The header information in column 402 identifies content information for a cell in different rows. The header information in row 404 describes content in the columns below the row. Table 400 is an example of table from a spreadsheet that may be used in a document, such as a Web page.

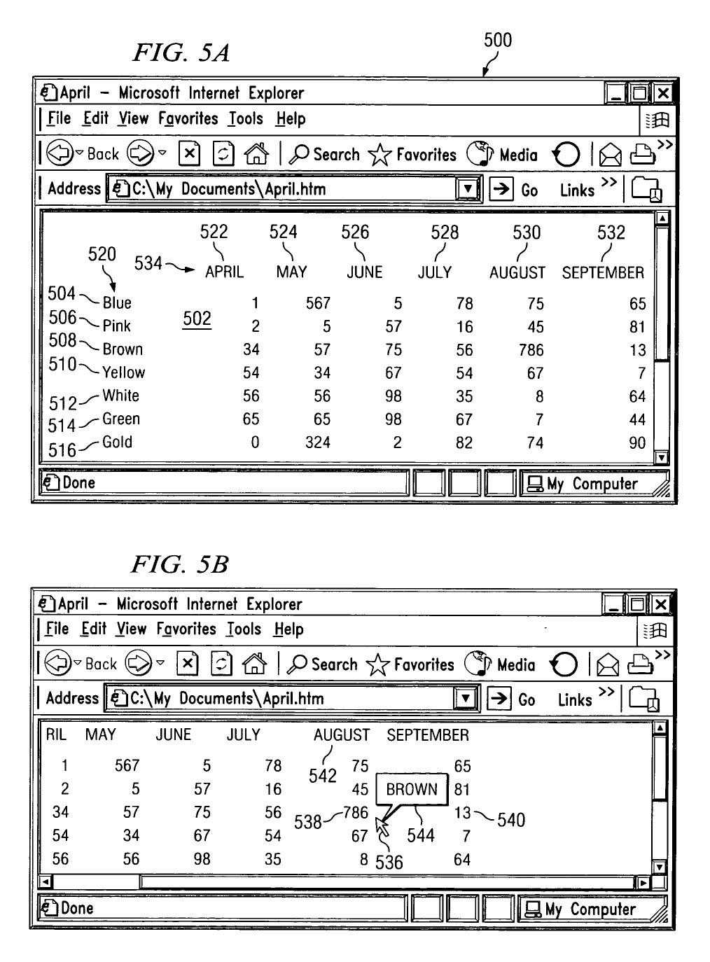

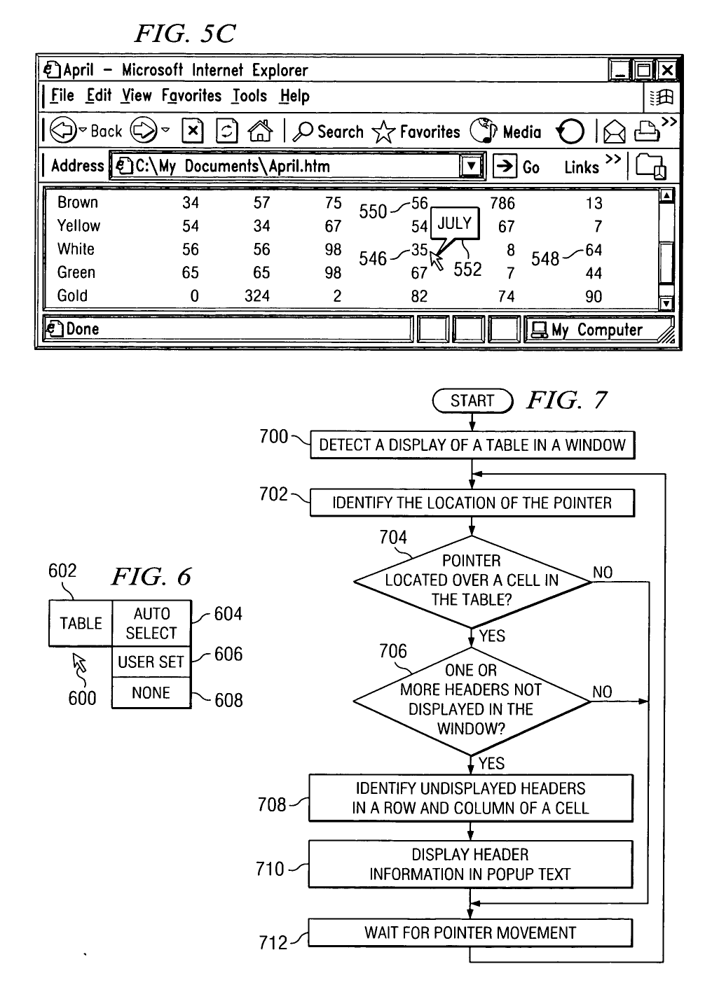

With reference now to FIG. 5A-5C, diagrams illustrating the display of a table are depicted in accordance with a preferred embodiment of the present invention. In this example, in FIG. 5A, window 500 is a window for a browser, such as browser 300 in FIG. 3. Table 502 is displayed within window 500 and is a table, such as table 400 in FIG. 4. As illustrated, the entire table can be seen in FIG. 5. As displayed, table 502 contains headers in cells 504, 506, 508, 510, 512 514, and 516 in column 520. Cells 522, 524, 526, 528, 530, and 532 contain headers in row 534. In these examples, the cells are not displayed with visible delineations as compared to the example in FIG. 4.

In some cases, the entire table being displayed in window 500 is long and complex enough to extend beyond the boundaries available in window 500. Also, the user may resize window 500 in the manner in which table 502 cannot be fully displayed within window 500.

In FIG. 5B, window 500 has been resized such that all of table 502 cannot be seen within window 500. The headers in column 520 for the rows are not visible within window 500. The mechanism of the present invention for the header information for a cell to be displayed to the user. For example, pointer 536 is positioned or hovering over cell 538. In this example, the header that cannot be seen by the user is associated with cell 538.

The mechanism of the present invention identifies the row and column for a cell over which pointer 536 is located. Cell 538 is located in row 540 and in column 542. The headers for row 540 and column 542 are identified. In these examples, the header for row 540 is located in cell 508 and the header for column 542 is located in cell 530. Specifically, the header found in cell 508 is for cell 538, which is out of the viewing area in window 500. In response to identifying this unviewable cell, the mechanism of the present invention presents the contents of cell 508 in popup text block 544. In this manner, the user is able to better understand the contents of cell 538 because the user is able to see all of the header information for that cell.

In FIG. 5C, table 500 has been resized such that the header information for the columns in row 534 are now shown within the display of window 500. In this example, pointer 536 is located over cell 546. The mechanism of the present invention identifies cell 546 as being in row 548 and column 550. Cell 528 contains the header for column 550, which is out of view. As a result, popup text block 552 is displayed.

In these examples, the popup text blocks are displayed in close proximity to the pointer. Depending upon the particular implementation, these popup text blocks may be displayed in other locations, such as one designated by the user. Additionally, other mechanisms for displaying text maybe implemented. For example, the text may be presented in a popup window. Further, the text may be displayed by using the contents of the header. Alternatively, an image of the header may be used.

Further, the mechanism of the present invention may allow the user to set preferences on how header information is displayed to the user.

Turning to FIG. 6, a diagram illustrating a menu with preferences for displaying text is depicted in accordance with a preferred embodiment of the present invention. In this example, pointer 600 has selected entry 602, which is a preference for displaying tables. Preferences are displayed in entries 604, 606, and 608. In entry 604, the browser is automatically allowed to select the appropriate heading.

In entry 606, the user selects or sets the header. With this option, the browser does not try to identify the header, but displays contents from the cells at the end of each row or column that cannot be seen. The user is allowed to select the cell to set the preferred header. For example, if both ends of a row cannot be seen, the content from these cells are displayed. If the user selects the content from the cell in the left side of the row, then the browser always uses the left most cell in the table as the header in displaying header information to the user. Next, in entry 608, no header information is displayed.

Turning next to FIG. 7, a flowchart for a process for displaying a table in a window is depicted in accordance with a preferred embodiment of the present invention. The process illustrated may be implemented in a browser, such as browser 300 in FIG. 3.

The process begins by detecting a display of a table in a window (step 700). Next, the location of the pointer is identified (step 702). A determination is made as to whether the pointer is located over a cell in the table (step 704). If the pointer is located over a cell in the table, a determination is made as to whether one or more headers are not displayed within the window (step 706).

If one or more headers cannot be seen, undisplayed headers in a row and column for the cell are identified (step 708). Undisplayed headers may be identified in a number of different ways. For example, the location of the top most left potion of the table may be compared with the location of the window to determine whether headers are out of view. Additionally, the location of the cells at the end of each row and column may be compared to the position of the window to determine whether any cells at the ends of the rows and columns are undisplayed. These cells, at the end of each row and column, are referred to as terminating cells in these examples. An assumption may be made that the terminating cells in the left side of the rows at the top portions of the columns contains headers. Alternatively, the information in each terminating cell at each end of the row and column may be compared with the contents in the other cells to determine whether the information in these cells are headers.

Thereafter, header information from the undisplayed headers are presented in a popup text block (Step 710). Thereafter, the process waits for a movement of the pointer (step 712). When a movement of the pointer occurs, the process returns to step 702 as described above.

With reference again step 706, if all of the headers are displayed in the window, the process also returns to step 702. In step 704, the process returns to step 712 if the pointer is not located over a cell in the table.

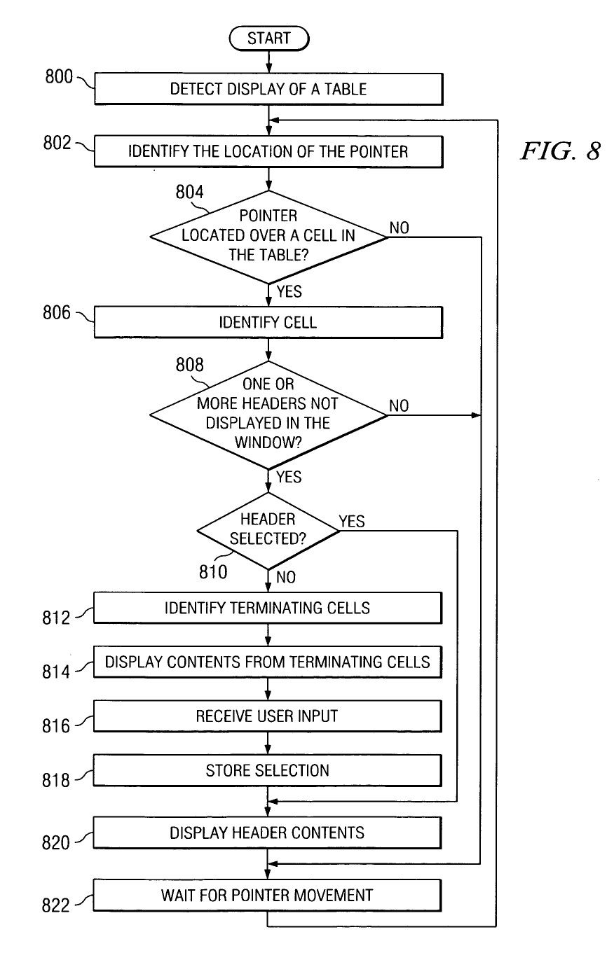

Turning next to FIG. 8, a flowchart of a process for displaying in which a user selects headers is depicted in accordance with a preferred embodiment of the present invention. The process illustrated in FIG. 8 may be implemented in a browser, such as browser 300 in FIG. 3.

The process begins by detecting a display of a table (step 800). Thereafter, the location of the pointer is identified (step 802). A determination is made as to whether the pointer is located over the cell in the table (step 804). If the pointer is located over a cell, the location of the cell is identified (step 806). A determination is made as to whether one or more headers are not displayed in the window (step 808).

If one or more headers are not displayed in the window, then a determination is made as to whether a header has been selected by the user (step 810). This step is performed to decide whether the user has selected a particular terminating cell on one end of a row or column as the cell containing header information. When such a selection is made, the selection is always used to determine whether headers are displayed.

If a header has not been selected by the user, terminating cells are identified in the row and column for the cell identified in step 806 (step 812). Then, contents from the terminating cells are displayed (Step 814). The content for the cells may be displayed in a popup window, such as a popup menu to allow the user to select one of the terminating cells as the header. Thereafter, user input selecting a terminating cell is received (step 816). For example, the user may select the contents for a terminating cell on the right end of a row as containing the header information. This selection is stored (step 818). In this example, the selection of the terminating cells on the right end is stored. In this manner, whenever the right end of a row cannot be seen, the contents of the terminating cell at the right end of the row are used to present the header information.

Thereafter, the header information is displayed (step 820). The process then waits for pointer movement to occur (step 822). When pointer movement occurs, the process returns to step 802 as described above.

With reference again to step 810, if a header has been selected, the process proceeds to step 820. In step 808, if all of the headers are displayed, the process proceeds to step 822. The process also proceeds to step 822 from step 804, if the pointer is not located over a cell in the table.

Thus, the present invention provides an improved method, apparatus, and computer instructions for displaying header information in a table. The mechanism of the present invention identifies when headers in a table are not displayed in a window in which the table is located. When this situation is present, the contents of a header are displayed for associated cells in the table. This display is through popup text or a popup window in these illustrative embodiments.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, in the illustrative embodiments, the tables are presented as tables in a HTML document displayed by the browser. The mechanism of the present invention may be applied to other documents other than HTML documents. For example, this mechanism may be applied to a table being displayed in a word processing document or a spreadsheet. Also, the mechanism of the present invention may be implemented in other components other than a browser. For example, the processes may be implemented in a graphical user interface associated with the operating system as a separate application, or a plug in to a browser. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for displaying header information in a table, the method comprising:
responsive to a movement of a pointer over the table displayed in a window, identifying a cell in the table over which the pointer is located;
responsive to identifying the cell, determining whether a header associated with the cell is out of view in the window; and
responsive to the header being out of view, displaying contents of the header.

2. The method of claim 1, wherein the displaying step comprises:
displaying a pop text block containing the contents.

3. The method of claim 1, wherein the determining step comprises:
identifying a row and a column for the cell;
identifying terminating cells for the row and the column to form a set of terminating cells; and
deciding whether a terminating cell in the set of terminating cells is the header associated with the cell.

4. The method of claim 3, wherein the deciding step comprises:
presenting contents from the set of terminating cells; and
receiving a user input for identifying a selected terminating cell as the header.

5. The method of claim 3, wherein the deciding step comprises:
comparing contents from the set of terminating cells to identifying the header.

6. The method of claim 1, wherein the table is displayed in a markup language document.

7. The method of claim 5, wherein the markup language document is a hypertext markup language document.

8. The method of claim 1, wherein the method is implemented in a browser program in which the table is displayed.

9. A data processing system for displaying header information in a table, the data processing system comprising:
identifying means, responsive to a movement of a pointer over the table displayed in a window, for identifying a cell in the table over which the pointer is located;
determining means, responsive to identifying the cell, for determining whether a header associated with the cell is out of view in the window; and
displaying means, responsive to the header being out of view, for displaying contents of the header.

10. The data processing system of claim 9, wherein the displaying means comprises:
displaying a pop text block containing the contents.

11. The data processing system of claim 9, wherein the determining means comprises:
identifying means for identifying a row and a column for the cell;
identifying means for terminating cells for the row and the column to form a set of terminating cells; and
deciding means for deciding whether a terminating cell in the set of terminating cells is the header associated with the cell.

12. The data processing system of claim 11, wherein the deciding means comprises:
presenting means for presenting contents from the set of terminating cells; and
receiving means for receiving a user input for identifying a selected terminating cell as the header.

13. The data processing system of claim 11, wherein the deciding means comprises:
comparing contents from the set of terminating cells to identifying the header.

14. The data processing system of claim 9, wherein the table is displayed in a markup language document.

15. The data processing system of claim 13, wherein the markup language document is a hypertext markup language document.

16. The data processing system of claim 9, wherein the method is implemented in a browser program in which the table is displayed.

17. A computer program product in a computer readable medium for displaying header information in a table, the computer program product comprising:
first instructions, responsive to a movement of a pointer over the table displayed in a window, for identifying a cell in the table over which the pointer is located;
second instructions, responsive to identifying the cell, for determining whether a header associated with the cell is out of view in the window; and
third instructions, responsive to the header being out of view, for displaying contents of the header.

18. The computer program product of claim 17, wherein the third instructions comprises:
sub-instructions for displaying a pop text block containing the contents.

19. The computer program product of claim 17, wherein the second instructions comprises:
first sub-instructions for identifying a row and a column for the cell;
second sub-instructions for identifying terminating cells for the row and the column to form a set of terminating cells; and
third sub-instructions for deciding whether a terminating cell in the set of terminating cells is the header associated with the cell.

20. The computer program product of claim 19, wherein the third sub-instructions comprises:
presenting instructions for presenting contents from the set of terminating cells; and
receiving instructions for receiving a user input for identifying a selected terminating cell as the header.

21. The computer program product of claim 19, wherein the third sub-instructions comprises:
comparing instructions for comparing contents from the set of terminating cells to identifying the header.

22. The computer program product of claim 17, wherein the table is displayed in a markup language document.

23. The computer program product of claim 21, wherein the markup language document is a hypertext markup language document.

24. The computer program product of claim 17, wherein the computer program product is implemented in a browser program in which the table is displayed.
